(19) United States
(12) Patent Application Publication
(10) Pub. No.: US 2025/0184914 A1
(43) Pub. Date: Jun. 5, 2025

(54) METHOD AND APPARATUS FOR DETERMINING TRANSMIT POWER OF SOUNDING REFERENCE SIGNAL IN MOBILE COMMUNICATIONS

(71) Applicant: MEDIATEK INC., Hsinchu City (TW)

(72) Inventor: Chi-Hsuan HSIEH, Hsinchu City (TW)

(21) Appl. No.: 18/840,662

(22) PCT Filed: Apr. 17, 2023
(86) PCT No.: PCT/CN2023/088673

§ 371 Date: Aug. 22, 2024

Related U.S. Application Data
(60) Provisional application No. 63/334,315, filed on Apr. 25, 2022.

(51) Int. Cl. H04W 52/32; H04L 5/00; H04W 74/0833

(52) U.S. Cl. CPC H04W 52/32; H04L 5/0048; H04W 74/0833

(57) ABSTRACT

Various solutions for transmit power determination for sounding reference signal (SRS) with respect to user equipment and network apparatus in mobile communications are described. An apparatus may determine a type of random access procedure. The apparatus may determine a transmit power control (TPC) command value according to the type of random access procedure. The apparatus may obtain an SRS power control variable according to the TPC command value. The apparatus may transmit an SRS to a network node according to the SRS power control variable.

### CROSS REFERENCE TO RELATED PATENT APPLICATION(S)

The present disclosure claims the priority benefit of U.S. Provisional Patent Application No. 63/334,315, filed on 25 Apr. 2022. The content of aforementioned application is herein incorporated by reference in its entirety.

### TECHNICAL FIELD

The present disclosure is generally related to mobile communications and, more particularly, to transmit power determination for sounding reference signal with respect to user equipment (UE) and network apparatus in mobile communications.

### BACKGROUND

Unless otherwise indicated herein, approaches described in this section are not prior art to the claims listed below and are not admitted as prior art by inclusion in this section.

Sounding reference signal (SRS) is a reference signal transmitted by the UE in the uplink direction which is used by the network to estimate the uplink channel quality over a wider bandwidth. SRS is an uplink reference signal which is transmitted by UE to the base station. SRS may provide information about the combined effect of multipath fading, scattering, Doppler and power loss of the transmitted signal. In 5G New Radio (NR), the SRS is transmitted by the UE for uplink channel sounding, which includes channel estimation and synchronization. An NR-SRS is an uplink orthogonal frequency division multiplexing (OFDM) signal filled with a Zadoff-Chu sequence on different subcarriers. For the purposes of communications, the SRS is used for closed-loop spatial multiplexing, uplink transmitting timing control and reciprocity multi-user downlink precoding.

The UE transmits the SRS, which is a predefined signal with known characteristics, at a specific time and frequency. The SRS configuration is provided to the UE by the network for transmitting the SRS. The SRS configuration may comprise time domain resources, frequency domain resources and transmit power configurations. However, in current NR SRS framework, the transmit power configurations for SRS are not well defined. Specifically, the current transmit power configurations for SRS are defined based on the 4-step random access channel (RACH) procedure. But the 2-step RACH procedure was newly introduced in 3^{rd} Generation Partnership Project (3GPP) Release-16. The current transmit power configurations for SRS did not consider the situations for the 2-step RACH procedure and is not applicable for the Release-16 UEs. Therefore, how to determine the SRS transmit power with the consideration of the 2-step RACH procedure is not clear and not defined yet.

Accordingly, how to design the SRS transmission framework becomes a critical issue in the newly developed wireless communication network. Therefore, there is a need to provide proper schemes to determine the transmit power for the SRS.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to transmit power determination for SRS with respect to user equipment and network apparatus in mobile communications.

In one aspect, a method may involve an apparatus determining a type of random access procedure. The method may also involve the apparatus determining a transmit power control (TPC) command value according to the type of random access procedure. The method may further involve the apparatus obtaining an SRS power control variable according to the TPC command value. The method may further involve the apparatus transmitting an SRS to a network node according to the SRS power control variable.

In one aspect, an apparatus may comprise a transceiver which, during operation, wirelessly communicates with at least one network node of a network side. The apparatus may also comprise a processor communicatively coupled to the transceiver. The processor, during operation, may perform operations comprising determining a type of random access procedure. The processor may also perform operations comprising determining a TPC command value according to the type of random access procedure. The processor may further perform operations comprising obtaining an SRS power control variable according to the TPC command value. The processor may further perform operations comprising transmitting, via the transceiver, an SRS to a network node according to the SRS power control variable.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to transmit power determination for sounding reference signal with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

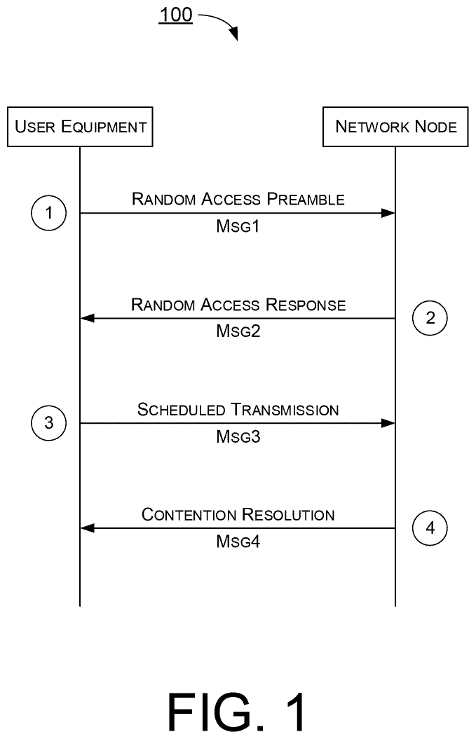

FIG. 1 illustrates an example scenario 100 under schemes in accordance with implementations of the present disclosure. Scenario 100 involves at least a network node and a UE, which may be a part of a wireless communication network (e.g., an LTE network, a 5G/NR network, an IoT network or a 6G network). Scenario 100 illustrates the 4-step RACH procedure framework. As the term implies, the 4-step RACH indicates a type of RACH procedure that comprises 4 steps from Message 1 (Msg1) to Message 4 (Msg4). Msg1 is for preamble transmission. The UE selects a random access preamble from a set of predefined preambles. The UE also selects a random sequence number for the preamble. After choosing the preamble and sequence number, the UE transmits the preamble on the physical random access channel (PRACH).

Msg2 is for random access response (RAR). Upon receiving Msg1, the network node sends a response called Msg2. Msg2 consists of several critical pieces of information, such as the time advance (TA) command for timing adjustment, the random access preamble identifier (RAPID) matching the preamble sent by the UE, and an initial uplink grant for the UE. The network node also assigns a temporary identifier called random access radio network temporary identifier (RA-RNTI) to the UE.

Msg3 is for scheduled uplink (UL) transmission. Using the initial uplink grant provided in Msg2, the UE transmits Msg3 on the physical uplink shared channel (PUSCH). Msg3 is a PUSCH which may carry a certain radio resource control (RRC) message (e.g., RrcRequest) or just be pure physical (PHY) data.

Msg4 is for contention resolution. After processing Msg3, the network node sends Msg4 to the UE. Msg4 is a media access control (MAC) data which is for contention resolution. The contention resolution message contains the UE's identity, confirming that the network node has correctly identified the UE, and contention has been resolved. At this step, network node provides the UE with a cell radio network temporary identifier (C-RNTI).

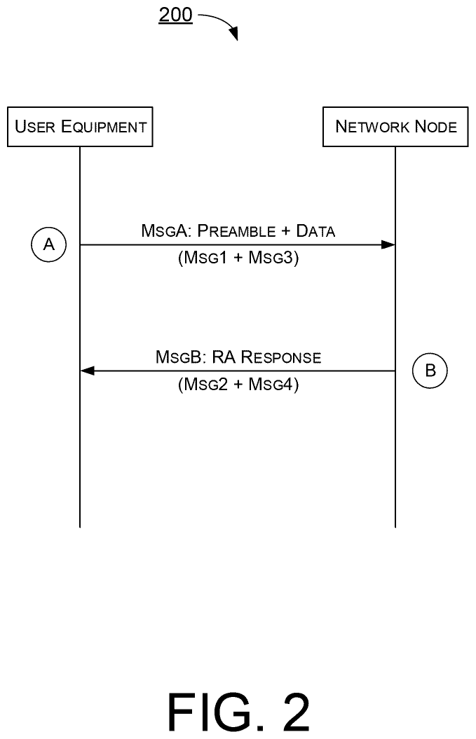

FIG. 2 illustrates an example scenario 200 under schemes in accordance with implementations of the present disclosure. Scenario 200 involves at least a network node and a UE, which may be a part of a wireless communication network (e.g., an LTE network, a 5G/NR network, an IoT network or a 6G network). Scenario 200 illustrates the 2-step RACH procedure framework. As the term implies, the 2-step RACH indicates a type of RACH procedure that comprises only 2 steps including Message A (MsgA) and Message B (MsgB). The 4-step RACH requires two round-trip cycles between the UE and the network node, which not only increases the latency but also incurs additional control-signaling overhead. The motivation of the 2-step RACH is to reduce latency and control-signaling overhead by having a single round trip cycle between the UE and the network node. This can be achieved by combining the preamble (Msg1) and the scheduled PUSCH transmission (Msg3) into a single message (MsgA) from the UE to the network node. Then by combining the random access response (Msg2) and the contention resolution message (Msg4) into a single message (MsgB) from the network node to the UE.

MsgA consists of a PRACH preamble and a PUSCH transmission, known as MsgA PRACH and MsgA PUSCH respectively. The MsgA PRACH preambles are separate from the 4-step RACH preambles, but can be transmitted in the same PRACH occasions (ROs) as the preambles of the 4-step RACH, or in separate ROs. The PUSCH transmissions are organized into PUSCH occasions (POs) which span multiple symbols and physical resource blocks (PRBs) with optional guard periods and guard bands between consecutive POs. Each PO consists of multiple demodulation reference signal (DMRS) ports and DMRS sequences, with each DMRS port/DMRS sequence pair known as PUSCH resource unit (PRU). The 2-step RACH supports at least one-to-one and multiple-to-one mapping between the preambles and PRUs.

After the UE transmits MsgA, it waits for the MsgB response from the gNB. There are three possible scenarios. First, the network node does not detect the MsgA PRACH, and no response is sent back to the UE. Then the UE retransmits MsgA or falls back to the 4-step RACH starting with a Msg1 transmission. Second, the network node detects MsgA preamble but fails to successful decode MsgA PUSCH. The network node sends back a fallbackRAR to the UE with the RAPID and an uplink grant for the MsgA PUSCH retransmission. The UE upon receiving the fallbackRAR, falls back to the 4-step RACH with a transmission of Msg3 (retransmission of the MsgA PUSCH). Third, the network node detects MsgA and successfully decodes MsgA PUSCH. The network node sends back a successRAR to the UE with the contention resolution ID of MsgA. The reception of the successRAR successfully completes the 2-step RACH procedure.

MsgB consists of the RAR and the contention resolution message. The RAR is sent when the network node detects a preamble but cannot successfully decode the corresponding PUSCH transmission. The contention resolution message is sent after the network node successfully decodes the PUSCH transmission. MsgB can contain backoff indication including fallbackRAR and/or successRAR. A single MsgB can contain the successRAR of one or more UEs. The fallbackRAR consists of the RAPID which indicates an uplink grant to retransmit the MsgA PUSCH payload and TA command. The successRAR consists of at least the contention resolution ID, the C-RNTI and the TA command.

In earlier versions of NR 3GPP Releases (i.e., Release-15), there was only one type of RACH procedure was defined, which is similar to LTE RACH procedure also known as the 4-step RACH procedure. In Release-16 NR version, 3GPP introduced a new 2-step RACH procedure which aims to improve the overall latency of RACH procedure. The benefit of having a 2-step RACH process over 4-step RACH process is that it reduces the network access latency. However, in current SRS transmission framework, the transmit power of the SRS was defined based on the Release-15 4-step RACH procedure and did not consider the newly introduced 2-step RACH procedure. This will cause some issues that the UE is not able to determine the SRS transmit power under the 2-step RACH procedure since the parameters/messages configured in the 4-step RACH procedure and the 2-step RACH procedure are different. The current SRS transmit power determination scheme is not applicable for the2-step RACH procedure.

Specifically, as defined in 3GPP Technical Specification 38.213, if a configuration for a nominal UE transmit power value P_{O_SRS,b,f,c}(qₛ) or for a fractional power control multiplier value α_{SRS,b,f,c}(qₛ) for a corresponding SRS power control adjustment state l for active uplink (UL) bandwidth part (BWP) b of carrier f of serving cell c is provided by higher layers, a closed loop power control component h_{b,f,c}(k)=0, k=0, 1, . . . , i, where k denotes the timing. Otherwise, the closed loop power control component h_{p,f,c}(k)=ΔP_{rampup,b,f,c}+δ_{msg2,b,f,c}. δ_{msg2,b,f,c} is the TPC command value indicated in the random access response grant corresponding to the random access preamble that the UE transmitted on active UL BWP b of carrier f of the serving cell c. In the determination of δ_{msg2,b,f,c}, it is determined based on the TPC command value carried in random access response grant of the 4-step RACH procedure. However, the definition of δ_{msg2,b,f,c} is not applicable for the 2-step RACH procedure. Accordingly, the UE is not clear how to determine the closed loop power control component and therefore is unable to determine the SRS transmit power.

In view of the above, the present disclosure proposes several schemes pertaining to transmit power determination for SRS with respect to UE and network apparatus in mobile communications. According to the schemes of the present disclosure, more clear definitions will be introduced for determining the transmit power of the SRS. Both 4-step RACH scenario and 2-step RACH scenario will be taken into account. The parameters/messages configured in the 4-step RACH procedure and the 2-step RACH procedure will be respectively used for determining the SRS transmit power. Accordingly, the UE is able to support SRS transmission for both 4-step RACH scenario and 2-step RACH scenario. The SRS transmission framework can be applicable for all UEs.

Specifically, in an event that a configuration for a nominal UE transmit power P_{O_SRS,b,f,c}(qₛ) value based on some path loss reference resource qₛ, or for a fractional power control multiplier α_{SRS,b,f,c}(qₛ) for a corresponding SRS power control adjustment state l for active UL BWP b of carrier f of serving cell c is not provided by higher layers, the UE may obtain the SRS power control variable h_{b,f,c}(0) from a power ramp up value and δ_{b,f,c}. δ_{b,f,c} is the TPC command value indicated in a random access response grant corresponding to a PRACH transmission according to Type-1 random access procedure, or in a random access response grant corresponding to MsgA transmissions according to Type-2 random access procedure with RAR message(s) for fallbackRAR, or the TPC command value indicated in a successRAR corresponding to MsgA transmissions for Type-2 random access procedure.

In some implementations, the UE may determine a type of random access procedure. The type of random access procedure may comprise a Type-1 random access procedure or a Type-2 random access procedure. The Type-1 random access procedure may comprise a 4-step RACH. The Type-2 random access procedure may comprise a 2-step RACH. Then, the UE may determine a TPC command value according to the type of random access procedure. The UE may obtain an SRS power control variable according to the TPC command value. The UE may transmit an SRS to a network node according to the SRS power control variable.

In some implementations, the TPC command value may be indicated in a random access response grant corresponding to a PRACH transmission according to the Type-1 random access procedure.

In some implementations, the TPC command value may be indicated in a random access response grant corresponding to MsgA transmissions according to the Type-2 random access procedure with an RAR message for a fallback RAR.

In some implementations, the TPC command value may be indicated in a success RAR corresponding to MsgA transmissions for the Type-2 random access procedure.

In some implementations, the TPC command value may comprises a δ_{b,f,c}, and wherein b denotes an active uplink bandwidth part, f denotes a carrier and c denotes a serving cell.

In some implementations, the UE may determine whether a nominal UE transmit power value or a fractional power control multiplier value is provided by the network node. In an event that the nominal user equipment transmit power value or the fractional power control multiplier value is not provided by the network node, the UE may obtain the SRS power control variable according to the TPC command value.

In some implementations, the UE may obtain the SRS power control variable from a power ramp up value and the TPC command value.

In some implementations, the UE may adjust or determine a power level of the SRS according to the SRS power control variable and transmit SRS to a network node.

In some implementations, if a configuration for a P_{O_SRS,b,f,c}(qₛ) value or for a α_{SRS,b,f,c}(qₛ) value for a corresponding SRS power control adjustment state l for active UL BWP b of carrier f of serving cell c is provided by higher layers, h_{p,f,c}(k)=0, k=0, 1, . . . , i; elase, h_{p,f,c}(0)=ΔP_{rampup,b,f,c}+δ_{b,f,c}, where δ_{b,f,c} is the TPC command value indicated in the random access response grant corresponding to a PRACH transmission according to Type-1 random access procedure, or in a random access response grant corresponding to MsgA transmissions according to Type-2 random access procedure with RAR message(s) for fallbackRAR, or the TPC command value indicated in a successRAR corresponding to MsgA transmissions for Type-2 random access procedure.

### Illustrative Implementations

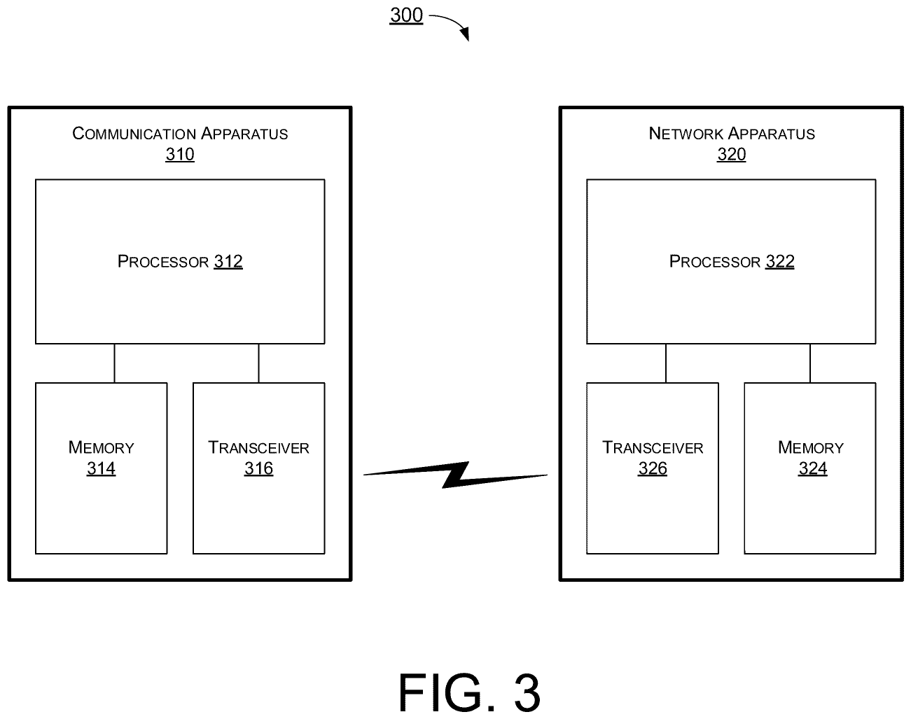

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to transmit power determination for sounding reference signal with respect to user equipment and network apparatus in mobile communications, including scenarios/schemes described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIOT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router or a gateway. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may determine a type of random access procedure. Processor 312 may determine a TPC command value according to the type of random access procedure. Processor 312 may obtain an SRS power control variable according to the TPC command value. Processor 312 may transmit, via the transceiver 316, an SRS to network apparatus 320 according to the SRS power control variable.

In some implementations, processor 312 may determine whether a nominal user equipment transmit power value or a fractional power control multiplier value is provided by the network node. In an event that the nominal user equipment transmit power value or the fractional power control multiplier value is not provided by the network node, processor 312 may obtain the SRS power control variable according to the TPC command value.

In some implementations, in obtaining the SRS power control variable, processor 312 may obtain the SRS power control variable from a power ramp up value and the TPC command value.

In some implementations, in transmitting the SRS, processor 312 may adjust or determine a power level of the SRS according to the SRS power control variable.

### Illustrative Processes

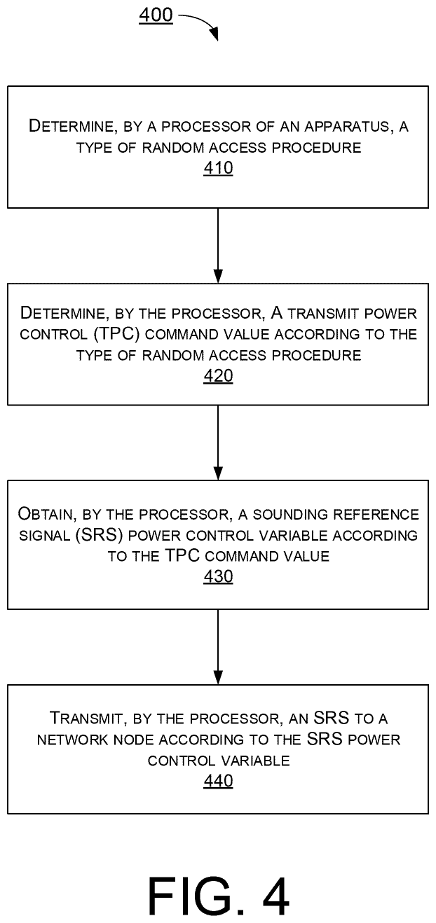

FIG. 4 illustrates an example process 400 in accordance with an implementation of the present disclosure. Process 400 may be an example implementation of above scenarios/schemes, whether partially or completely, with respect to transmit power determination for sounding reference signal with the present disclosure. Process 400 may represent an aspect of implementation of features of communication apparatus 310. Process 400 may include one or more operations, actions, or functions as illustrated by one or more of blocks 410 to 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 determining a type of random access procedure. Process 400 may proceed from 410 to 420.

At 420, process 400 may involve processor 312 determining a TPC) command value according to the type of random access procedure. Process 400 may proceed from 420 to 430.

At 430, process 400 may involve processor 312 obtaining an SRS power control variable according to the TPC command value. Process 400 may proceed from 430 to 440.

At 440, process 400 may involve processor 312 transmitting an SRS to a network node according to the SRS power control variable.

In some implementations, process 400 may further involve processor 312 determining whether a nominal user equipment transmit power value or a fractional power control multiplier value is provided by the network node. In an event that the nominal user equipment transmit power value or the fractional power control multiplier value is not provided by the network node, process 400 may involve processor 312 obtaining the SRS power control variable according to the TPC command value.

In some implementations, in obtaining the SRS power control variable, process 400 may involve processor 312 obtaining the SRS power control variable from a power ramp up value and the TPC command value.

In some implementations, in transmitting the SRS, process 400 may involve processor 312 adjusting or determining a power level of the SRS according to the SRS power control variable.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a type of random access procedure;
determining, by the processor, a transmit power control (TPC) command value according to the type of random access procedure;
obtaining, by the processor, a sounding reference signal (SRS) power control variable according to the TPC command value; and
transmitting, by the processor, an SRS to a network node according to the SRS power control variable.

2. The method of claim 1, wherein the type of random access procedure comprises a Type-1 random access procedure or a Type-2 random access procedure.

3. The method of claim 2, wherein the Type-1 random access procedure comprises a 4-step random access channel (RACH), and wherein the Type-2 random access procedure comprises a 2-step RACH.

4. The method of claim 2, wherein the TPC command value is indicated in a random access response grant corresponding to a physical random access channel (PRACH) transmission according to the Type-1 random access procedure.

5. The method of claim 2, wherein the TPC command value is indicated in a random access response grant corresponding to MsgA transmissions according to the Type-2 random access procedure with a random access response (RAR) message for a fallback RAR.

6. The method of claim 2, wherein the TPC command value is indicated in a success random access response (RAR) corresponding to MsgA transmissions for the Type-2 random access procedure.

7. The method of claim 1, wherein the TPC command value comprises a δ_{b,f,c}, and wherein b denotes an active uplink bandwidth part, f denotes a carrier and c denotes a serving cell.

8. The method of claim 1, further comprising:
determining, by the processor, whether a nominal user equipment transmit power value or a fractional power control multiplier value is provided by the network node,
wherein the SRS power control variable is obtained in an event that the nominal user equipment transmit power value or the fractional power control multiplier value is not provided by the network node.

9. The method of claim 1, wherein the obtaining of the SRS power control variable comprises obtaining the SRS power control variable from a power ramp up value and the TPC command value.

10. The method of claim 1, wherein the transmitting of the SRS comprises adjusting or determining a power level of the SRS according to the SRS power control variable.

11. An apparatus, comprising:
a transceiver which, during operation, wirelessly communicates with at least one network node of a network side; and
a processor communicatively coupled to the transceiver such that, during operation, the processor performs operations comprising:
determining a type of random access procedure;
determining a transmit power control (TPC) command value according to the type of random access procedure;
obtaining a sounding reference signal (SRS) power control variable according to the TPC command value; and
transmitting, via the transceiver, an SRS to a network node according to the SRS power control variable.

12. The apparatus of claim 11, wherein the type of random access procedure comprises a Type-1 random access procedure or a Type-2 random access procedure.

13. The apparatus of claim 12, wherein the Type-1 random access procedure comprises a 4-step random access channel (RACH), and wherein the Type-2 random access procedure comprises a 2-step RACH.

14. The apparatus of claim 12, wherein the TPC command value is indicated in a random access response grant corresponding to a physical random access channel (PRACH) transmission according to the Type-1 random access procedure.

15. The apparatus of claim 12, wherein the TPC command value is indicated in a random access response grant corresponding to MsgA transmissions according to the Type-2 random access procedure with a random access response (RAR) message for a fallback RAR.

16. The apparatus of claim 12, wherein the TPC command value is indicated in a success random access response (RAR) corresponding to MsgA transmissions for the Type-2 random access procedure.

17. The apparatus of claim 11, wherein the TPC command value comprises a δ_{b,f,c}, and wherein b denotes an active uplink bandwidth part, f denotes a carrier and c denotes a serving cell.

18. The apparatus of claim 11, wherein, during operation, the processor further performs operations comprising:
determining whether a nominal user equipment transmit power value or a fractional power control multiplier value is provided by the network node,
wherein, in obtaining the SRS power control variable, the processor obtains the SRS power control variable in an event that the nominal user equipment transmit power value or the fractional power control multiplier value is not provided by the network node.

19. The apparatus of claim 11, wherein, in obtaining the SRS power control variable, the processor obtains the SRS power control variable from a power ramp up value and the TPC command value.

20. The apparatus of claim 11, wherein, in transmitting the SRS, the processor adjusts or determines a power level of the SRS according to the SRS power control variable.
